(19) United States
(12) Patent Application Publication
(10) Pub. No.: US 2022/0056296 A1
(43) Pub. Date: Feb. 24, 2022

(54) CONDUCTIVE INK JET PRINTING INK COMPOSITION

(71) Applicant: ECKART GMBH, Hartenstein (DE)

(72) Inventors: Volker Jordan, Wesel (DE); Stefan Engel, Wesel (DE); Wolfgang Herzing, Wesel (DE)

(21) Appl. No.: 17/415,264

(22) PCT Filed: Dec. 12, 2019
(86) PCT No.: PCT/EP2019/086225

§ 371 Date: Jun. 17, 2021

(30) Foreign Application Priority Data
Dec. 20, 2018 (EP) 18214389.1

(51) Int. Cl. C09D 11/52; C09D 11/322; C09D 11/36; C09D 11/037; C09D 11/033; C09D 11/14; B41M 5/00

(52) U.S. Cl. CPC C09D 11/52; C09D 11/322; C09D 11/36; B41M 5/0023; C09D 11/033; C09D 11/14; C09D 11/037

(57) ABSTRACT

A conductive ink jet printing ink composition is provided comprising the following components: (a) 60-84.5 wt.-% of an organic solvent or a mixture of organic solvents, (b) 0.5-5 wt.-% of a binder, wherein the binder comprises ethyl cellulose in an amount of a range of 85 to 100 wt.-%, based on the total amount of the binder, (c) 15-25 wt.-% of silver particles having a d50-value in a range of 130 nm to 800 nm, (d) optionally antioxidizing agents, (e) optionally a dispersing agent for the silver particles different from binder (b), wherein all amounts are referred to the total amount of the ink jet printing ink composition, if not defined otherwise.

The present invention relates to conductive ink compositions, the manufacture of such compositions, and the use of these compositions in an ink jet printing process.

In an ink jet printing process, tiny drops of ink jet printing ink are projected directly on the surface of a substrate for printing, without physical contact between the printing device and the substrate surface. The placement of each drop on the printing surface is controlled electronically. The ink jet printing technology has become an important technology for printing variable data and images on various substrates, such as paper, cardboard, cans, bottles, foils, etc. Ink jet technology allows to print data and images at high speed and is capable of providing high definition prints.

Various droplet formation processes have been developed in the past. Droplet formation can be effected for example electrostatically, magnetically, piezo electrically, electro thermally, via mechanical micro valves or by spark discharge. Irrespective of the manner of droplet formation, ink jet technology divides in principle into two categories, viz. continuous ink jet (CIJ) and impulse or drop-on-demand (DOD) technology.

In continuous ink jet technology, ink flows under pressure through a nozzle to form droplets that are applied to a substrate in a continuous jet. In the impulse technology the ink reservoir is kept at or below atmospheric pressure. A droplet of ink is only released from the printing nozzle in response to the droplet-forming unit being subjected to a controlled stimulating impulse. This technology is currently not only used in ink jet printers for professional and private use, but also in 3D printing technology.

Metal particles such as silver nanoparticles have been used to obtain reflective surfaces with metallic glint. For example, in WO 2008/024542 an ink for use in an ink jet printing process for obtaining reflective surfaces is disclosed comprising water as a solvent and 2-40 wt.-% of metal particles (silver, gold, zinc, tin, copper, nickel, cobalt, rhodium, palladium, or platinum) with an average particles size of less than 5 μm.

It has been recognized that when a conductive ink is used in an ink jet printing process, this technology can be used to provide conductive networks in a fast, reliable, and flexible way, without the need to use any photographic masks. This technology is in principle also suited to provide a conductive pattern on a variety of substrates, including flexible substrates, provided the conductive composition
can be cured, dried or sintered at relatively low temperature,
shows a good adhesion to the substrate, and
shows a good electrical conductivity.

In general, a conductive ink composition comprises
a solvent or a mixture of solvents,
a binder or a mixture of binders, and
a conductive pigment.

Such compositions are known in the art, for example from WO 2015/023370. In the composition submicron silver particles are used in combination with a thermoplastic resin and optionally an organic diluent or solvent.

In U.S. Pat. No. 6,979,416 B2 an ink jet printing ink is disclosed which comprises metal powders in a wide range of particle sizes, binders such as cellulose resin, vinyl resin or petroleum resin and solvents.

In EP 1571186 a ink composition for use in an ink jet printing process is disclosed that comprises colloidal metal particles (nickel, copper, gold, platinum, palladium or amalgamates thereof, a dispersing agent with a molecular weight in the range from 200 to 30,000 g/mol, and a solvent mixture with water or an organic solvent that is miscible with water. The metal particles have a diameter of at most 200 nm.

In CN 103146260 a conductive ink composition is disclosed that can be used in an ink jet printing process. The binder is based on acrylates.

In CN 203967239 U a paper coated by an ink jet printing ink forming an ultrahigh frequency RFID antenna is described. The ink jet printing ink comprises nano silver particles and has many different components.

WO 2017121982 A1 discloses a process for applying a conductive paste to a glass substrate. The conductive paste contains conductive particles such as Ag particles and glass frit particles to make this ink compatible to the glass substrate.

It was found that the conductive ink compositions from the state-of-the art show a tendency to segregate after some time, so they need to be re-dispersed prior to use or suitable dispersant needs to be added to these compositions. Such dispersants can reduce the conductivity of the ink after application and drying on the substrate.

Nanoparticles were used in the past for improving the stability of the solution. However, they are suspected to present environmental disadvantages and healthy problems. Also they may be sensitive towards oxidation which strongly diminishes the conductivity in cured films. Therefore, it would be desirable to have a stable solution using bigger metal particles.

On the other hand many ink formulations using lager silver particles are prone to nozzle clogging when used with ink jet technology.

Many ink jet formulations in the art have many different components, which decreases the versatility of their use. For example, such inks comprise glass particles or additional conductive particles like graphite, graphene or nanotubes.

The problem of the present invention is to find a conductive ink jet printing ink that is highly capable of being used in state-of-the-art ink jet printing apparatus for printing a variety of conductive patterns on a variety of substrates without the disadvantages of the prior art conductive ink compositions.

A further problem is to provide a method of making such an ink jet printing ink.

The problems were solved by providing an ink jet printing ink composition comprising the following components:

(a) 60-84.5 wt.-% of an organic solvent or a mixture of organic solvents,

(b) 0.5-5 wt.-% of a binder, wherein the binder comprises ethyl cellulose in an amount of a range of 85 to 100 wt.-%, based on the total amount of the binder,

(c) 15-25 wt.-% of silver particles having a d₅₀-value in a range of 130 nm and 800 nm,

(d) optionally antioxidizing agents,

(e) optionally a dispersing agent for the silver particles different from binder (b), wherein all amounts are referred to the total amount of the ink jet printing ink composition, if not defined otherwise.

In a preferred embodiment, the ink jet printing ink composition comprises the components (a), (b), (c) and (e) in an amount of a range of 95 to 100 wt.-%, based on the total composition.

Further preferred embodiments are depicted in claims 3 to 11.

The problem was further solved by providing a method of producing an ink jet printing ink composition, characterized that it comprises the following steps:
(i) Providing a silver particle dispersion having a d₅₀-value in a range of 130 nm and 800 nm and optionally coating the silver particles with a dispersing agent (e)
(ii) Optionally drying the silver pigment dispersion of step (i),
(iii) preparing a first dispersion by dissolving the binder (b) in the organic solvent or a mixture of organic solvents (a),
(iv) adding the silver pigment dispersion of step (i) or the silver pigment powder of step
(ii) to the dispersion of step (iii) under stirring and/or impact of ultrasound.

In a further embodiment the present invention relates to the use of the Ink jet printing ink composition in a drop-on-demand ink jet printing process on a substrate to form a conductive layer.

In a further embodiment the present invention relates to a process to apply a conductive line or a pattern to a substrate, characterized in that,

(i) an ink jet printing ink is printed by a drop-on-demand ink jet process or a continuous ink jet process on a substrate,

(ii) optionally the printed ink is dried at temperatures of 35° C. to 80° C. and

(iii) the printed ink is sintered at temperatures of 400 to 600° C.

### DETAILED DESCRIPTION

Solvents (a)

In the ink jet composition according to the present invention an organic solvent or a mixture of organic solvents is used. As used in the meaning of this invention the words “solvent” and “organic solvent” are equivalent.

In a further preferred embodiment, the ink jet printing ink has a flash point of at least 61° C., preferably at least 62° C. The “flash point” of a volatile material is the lowest temperature at which vapours of the ink composition will ignite, given an ignition source. In this invention the flash point is determined according to the method of Abel-Pensky.

The flash point of the ink jet printing ink is mainly determined by the solvents used therein.

The organic solvent is preferably a polar organic solvent, and examples include alcohols (such as methyl alcohol, ethyl alcohol, propyl alcohol, butyl alcohol or isopropyl alcohol, ketones (such as acetone, methyl ethyl ketone, and cyclohexanone and the like), carboxylate esters (such as methyl acetate, ethyl acetate, propyl acetate, butyl acetate, methyl propionate, and ethyl propionate and the like), and ethers (such as diethyl ether, dipropyl ether, tetrahydrofuran and dioxane, and the like).

In particular, the organic solvent preferably contains one or more types of an alkylene glycol ether that is a liquid at ambient temperature and pressure.

The alkylene glycol ether can be an ethylene glycol based ether or propylene glycol based ether which contains any of a methyl, n-propyl, i-propyl, n-butyl, i-butyl, hexyl, or 2-ethyl hexyl resin group and/or an allyl or phenyl group having a double bond as a base. These alkylene glycol ethers are colorless with little odor, and have an ether group and a hydroxyl group in the molecule, and therefore demonstrate the properties of both alcohols and ethers, and are liquid at room temperatures. Furthermore, these alkylene glycol ethers can be monoethers where only one of the hydroxyl groups have been substituted, or can be diethers, where both of the hydroxyl groups have been substituted, and furthermore a plurality of types can be combined and used together.

In a particular embodiment, the organic solvent preferably is or comprises a blend of an alkylene glycol diether and an alkylene glycol monoether.

With such a blend an optimized viscosity can be easily reached. This blend ensures no print head damage and a low odor. Additionally the VOC output is not as high as in case of typical solvents with high volatility such as e.g. acetone or ethyl acetate.

Examples of the alkylene glycol monoether include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monomethyl ether, dipropylene glycol monomethyl ether, dipropylene glycol monoethyl ether and the like.

Examples of alkylene glycol diethers include ethylene glycol dimethyl ether, ethylene glycol diethyl ether, ethylene glycol dibutyl ether, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropyleneglycol dimethyl ether, dipropylene glycol diethyl ether and the like.

Preferred organic solvents for the ink jet printing ink are propylenglycol n-butylether, butyl glycolacetate, ethyleneglycol n-butyl ether, ethylene glycol monoethyl ether, diethylene glycol monoethyl ether, ethylene glycol monomethyl ether, diethylene glycol monomethyl ether, triethylene glycol monobutyl ether, tetraethylene glycol monomethyl ether, tetraethylene glycol monoethyl ether, diethylene glycol dibutyl ether, dipropylenglycol dimethylether, propyleneglycol diethyl ether, dipropylene glycol diethyl ether, isopropanol, ethylacetate, butyl glycol, dibutyl glycol and mixtures thereof.

In a further preferred embodiment, the organic solvent preferably is or comprises a blend of propylenglycol n-butyl ether and dipropylenglycol dimethyl ether. Within this blend dipropylenglycol dimethylether complies with all product regulations. Propylenglycol n-butylether on the other hand has the property to slightly etch certain polymeric substrates, like e.g. polyethylene terephthalate, polymethyl methacrylate, polyethylene, polycarbonate, an epoxy resin, polyimide, polyamide, polyester, ensuring a better adhesion of the conductive film to the substrate. Both solvents furthermore have an optimized behavior with respect to drying properties and viscosities in ink jet printing.

It will be appreciated by a person skilled in the art that the organic solvent or mixture of organic solvents is preferably meant to be a free of water solvent. In case such a solvent is used as purchased, the amount of water content shall not be higher than 3 wt-%, preferably not higher than 1.5 wt.-%, based on the total amount of solvent. Most preferably, the solvent is essentially free of water, which is meant to be in the context of this invention that the water content is below of 1 wt.-%.

The ink jet printing ink composition according to the present invention comprises a solvent or a mixture of organic solvents in an amount of a range of 60 to 84.5 wt.-%, based on the total weight of the composition. Preferably the amount of solvent or a mixture of organic solvents is in a range of 76.3 to 83 wt.-% and more preferably in a range of 77.3 to 82 wt.-%.

Below an amount of 60 wt.-% the composition becomes too viscous to be usable in ink jet printing technology. Furthermore agglomeration of the silver particles may occur.

Above an amount of 84.5 wt.-% the efficiency of the printing ink lacks in the sense that a concomitant too low amount of the silver particles is used in the printing ink. Furthermore, the emission of organic solvent during drying is too high.

Silver Particles (b):

In the composition according to the present invention a silver conductive pigment is used, wherein the amount is in a range of 15 to 25 wt.-%, based on the total weight of the composition. Preferably, the amount of the conductive pigment is in a range of 17.5 to 23 wt.-%, each based on the total weight of the composition.

It has been found that compositions with amounts of silver particles above 25 wt.-% tend to an undesired nozzle clogging which make the use in ink jet printing impossible. Below 15 wt.-% the efficiency of the composition with respect to the conductive pigment is too low.

The particle size of the silver particles is of crucial importance. The particle size distribution is determined with laser scattering methods and is displayed as volume averaged cumulative frequency distribution. From this distribution function the d₁₀, d₅₀ or d₉₀ value indicates that 10%, 50% or 90%, respectively, of the pigments have a diameter which is equal to or smaller than the value specified in each case.

The d₁₀-value is a measure of the content of fine particles, the median d₅₀-value is a measure of the average particle size (though the median is not equal to the arithmetical average value) and the d₉₀-value is a measure of the content of coarse particles in the whole size distribution.

According to this invention the particle size is determined with a Mastersizer 2000 (Quantachrome) apparatus according to the recommendation of the manufacturer using Mie-theory for data evaluation. During or just before the measurement the silver particles are treated with ultra sound in order to dissolve loose agglomerates. Thus the primary size distribution can be essentially determined.

According to this invention the silver particles have a d₅₀-value in a range of 130 nm to 800 nm, preferably in a range of 150 nm to 650 nm and most preferably in a range of 160 to 400 nm.

Below of a d₅₀ of 130 nm the silver particles tend to be difficult to be stabilized for longer time, i.e. agglomeration commences. In case of very small silver particles like about 10 nm of 5 nm, these particles are very difficult to be stabilized for longer time and besides agglomeration oxidation may occur. Therefore, it is of advantage to use larger silver particles to avoid these problems. Furthermore, nano silver particles are deemed to have difficulties in their approval according to safety regulation affairs. For example, silver nano particles are listed since 2013 in the CoRAP (Community Rolling Action Plan) list. Furthermore, they are very expensive.

Above a d₅₀ of 800 nm nozzle clogging in the print head can be observed. Furthermore, the conductivity of printed and sintered films can decrease.

In a further preferred embodiment, the silver particles, the ink jet printing ink composition have a d₉₀-value in a range of 500 to 2,500 nm and further preferred in a range of 600-2,000 nm. Above a d₉₀-value of 2,500 nm nozzle clogging can be observed.

The silver particles are preferably stabilized by a dispersing agent (e). The amount of this agent can be low and preferably it is 2 wt.-%, based on the total weight of the composition.

The dispersing agent (e) or stabilizer is different from ethyl cellulose. It can be chosen from known stabilizers such as citrates, polyvinylpyrrolidone, polyvinyl alcohol, thiols and their derivatives, amines, carboxylic acids and their carboxylate derivatives, polyethylene glycols, and mixtures thereof.

In a preferred embodiment the dispersing agent (e) is a fatty acid with at least 6 C-atoms. The fatty acids preferably have up to 22 C-atoms. Typical examples are palmitic acid or stearic acid.

Usually this stabilizing agent will be utilized during the step of formation of the silver particles and will be adsorbed of the surface of the silver nanoparticles.

Silver particles can be produced by several methods like wet-chemical reduction of a silver salt, laser ablation, electrochemical methods (e.g. DE 112012001784 B4) or electrobeam lithography. In preferred embodiments the silver particles are produced by well-known wet-chemical reduction of a silver salt, typically silver nitrate, and in-situ stabilization by a suitable dispersing agent.

The silver particles are well stabilized in the printing ink composition in order not to form agglomerates, which cannot be redispersed any more. Therefore, it is preferred that the silver particles do not form super lattice forms like, for example, a “flower-shape” in which numerous particles are agglomerated forming large particles to avoid nozzle clogging of the ink head.

In a preferred embodiment the silver particles are essentially spherical particles.

Such spherical particles ensure a highest packaging density in the sintered conductive layers. Furthermore, the impact of the particles on the viscosity of the ink jet printing ink is lower than in any other form. During the printing process the ink jet printing ink will be pumped in the ink in print head or ink feeding system and here spherical particles have the lowest impact on the viscosity and flow behaviour, ensuring constant flow properties.

Binder (c):

In the composition according to the present invention 0.5-5 wt.-% of a binder, wherein the binder comprises ethyl cellulose in an amount of a range of 85 to 100 wt.-%, based on the total amount of the binder, is used. In a preferred embodiment, the ink jet printing ink composition has a binder which comprises ethyl cellulose in an amount of a range of 95 to 100 wt.-%, based on the total amount of the binder. In a further embodiment the binder is only ethyl cellulose.

The binder can comprise other binders such as polyvinyl pyrrolidone, CAB or acrylate, in a small amount up to 15 wt.-%, preferably of up to 5 wt.-% based on the content of the whole binder. Larger amounts of other binders proofed not to be advantageous with respect to stability of the silver particles or conductivity or films obtained after printing.

Ethyl cellulose proved to be a very good binder with low impact on the conductivity. Furthermore, ethyl cellulose can additionally stabilize the silver particles with respect to their agglomeration stability. Furthermore, ethyl cellulose acts as viscosity regulating agent. Because of these combined beneficial properties only rather small amounts of this component are needed. The amount of ethyl cellulose is in a range of 0.5 to 5 wt.-%, preferably in a range of 0.6 to 3.5 and more preferably in a range of 0.7 to 2.5 wt.-% and most preferably in a range of 0.75 to 1.5 wt.-%, based on the weight of the total composition.

Such low amounts ensure a minimum impact of this organic compound on the conductivity of the cured film. Ethyl cellulose has a strong impact on the viscosity of the ink jet printing ink and therefore amounts larger than 5 wt.-%, preferably larger than 3.5 wt.-%, lead to unacceptably high viscosities.

Ink Jet Printing Ink:

In a very preferred embodiment the ink jet printing ink composition of this invention comprises the components (a) solvents, (b) silver particles, (c) binder and (e) stabilizer in an amount of a range of 95 to 100 wt.-%, based on the total composition. In a further preferred embodiment the amount of these components is in a range of 97 to 100 wt.-% and in a most preferred embodiment in a range of 99 to 100 wt.-%.

Such compositions do have the advantage that they comprise only a small amount of different components. Thus, the compositions are easy to prepare and to handle and they can be utilized in many different applications.

It is easy to prepare and because of the optimized properties of the components only small amounts of binder or stabilizer is needed. Such components may have a negative impact on the conductivity of cured films after printing as they are non-conductive agents located on the surface of the silver particles. If the film is not perfectly sintered these remaining components may still be present at the interface of silver particles contacting each other and may create a resistance there.

Therefore, in a preferred embodiment, the ink jet printing ink composition does not contain any further conductive particles based on carbon, such as graphite, graphene, oxidized graphite, oxidized graphene, carbon nanotubes or the like.

In further preferred embodiments, the ink jet printing ink composition does not contain further components like glass particles. This kind of particles is often found in inks, when printing on glass substrates or on solar cells is intended.

It is crucial that the viscosity of the ink jet printing ink composition has a viscosity in a range of 3 to 25 mPas, further preferred of in a range of 4-20 mPas and most preferred in a range of 4.5-16 mPas. Ink jet printing inks need such low viscosities to be utilized with this printing technique.

The viscosity is determined at a temperature of 25° C. with a Brookfield rotational viscosimeter LV, Model DV-II+ using spindle no. 61 at 100 rpm.

In a preferred embodiment of the ink jet printing ink composition the ratio of the amount of binder to the amount of silver particles is in a range of 3% to 10% and further preferred in a range of 4 to 7%. The binder can be used in such low ratios because of its outstanding properties of binding and of stabilization. Larger amounts may lead to too high viscosities of the ink.

In a further embodiment of the ink jet printing ink composition comprises 2 wt.-%, preferred <1.5 wt.-% and most preferred <1 wt.-%, each based on the total weight of the composition, of an antioxidizing agent (d). Such agents can help to stabilize the silver particles against oxidation.

Examples for antioxidizing agents are ascorbic acid or vitamin C (E300), ascorbates of sodium (E301), of calcium (E302), diacetyl 5-6-1 ascorbic acid (E303), palmityl 6-1 ascorbic acid (E304); citric acid (E330), citrates of sodium (E331) of potassium (E332) and of calcium (E333); Tartric acid (E334), tartrates of sodium (E335), potassium (E336) and of sodium and of potassium (E337); butyl hydroxy anisole (E320) and butyl hydroxy toluene (E321); gallates of octyl (E311) or of dodecyl (E312); lactates of sodium (E325), of potassium (E326) or of calcium (E327); lecithins (E322); natural tocopherols (E306), synthesis of α-tocopherol (E307), synthesis of γ-tocopherol (E308) and synthesis δ-tocopherol (E309), wherein all of the tocopherols form vitamin E; eugenol, thymol and/or cinnamaldehyde, as well as a mixture of two or more of these antioxidizing agents.

In embodiments wherein the ink jet printing ink composition includes such antioxidizing agents, the amount of the components a) solvents, b) silver particles, c) binder and e) stabilizer in a range of 95 to 100 wt.-%, preferably in a range of 96 to 99 wt.-% and more preferably in a range of 97 to 98 wt.-%, each based on the total composition.

A preferred ink jet printing ink composition comprises or consists of the following components:
(a) 76.3 to 83 wt.-% of an organic solvent or a mixture of organic solvents,
(b) 0.7 to 2.5 wt.-% of ethyl cellulose as the binder,
(c) 17.5 to 23 wt.-% of silver particles having a d₅₀-value in a range of 130 nm to 800 nm,
(d) optionally antioxidizing agents,
(e) optionally a dispersing agent for the silver particles different from binder (b), wherein all amounts are referred to the total amount of the ink jet printing ink composition, if not defined otherwise.

In a further aspect a method of producing an ink jet printing ink composition is provided, which is characterized that it comprises the following steps:

(i) Providing a silver particle dispersion having a d₅₀-value in a range of 130 nm and 800 nm and optionally coating the silver particles with a dispersing agent (e)

(ii) Optionally drying the silver pigment dispersion of step (i),

(iii) preparing a first dispersion by dissolving the binder (b) in the organic solvent or a mixture of organic solvents (a),

(iv) adding the silver pigment dispersion of step (i) or the silver pigment powder of step (ii) to the dispersion of step (iii) under stirring and/or impact of ultrasound.

This method ensures a good solubility of the binder and therefore no clumping together of the metal particles leading to a homogenous ink jet printing ink.

The conductive ink jet printing ink can be printed on various substrates. Examples for the substrates are plastics like is polyethylene terephthalate, polymethyl methacrylate, polyethylene, polypropylene, polycarbonate, an epoxy resin, polyimide, polyamide, polyester, polyaniline, polyvinylidene fluoride or copolymers such as ABS (acrylonitrile, butandiene, styrol) or combinations of such plastics. Further suitable substrates are glass or paper designed for printed electronics applications.

Various patterns can be printed using all the advantages of ink jet printing here. The patterns can be adapted individually to the needs of the applicant, leading up to only one lot size. As ink jet printing is a contactless printing method no further preparations typical for other printing methods like e.g. provision of sieves need to be made.

The substrates are printed by the drop-on-demand or the continuous ink jet technique. The drop-on-demand technique is preferred as here a wide use of the printing ink with different printing heads is possible.

The applications of the printed substrates can be RFID antenna, organic thin film transistor (OTFT), a PCB plate or a solar grid.

After ink jet printing on the substrate the ink is preferably first dried at a temperature in a range of 35° C. to 80° C. and more preferably in a range of 40° C. to 70° C. This drying step lasts for about a few seconds to about half an hour. Most of the solvents are evaporated here.

Then the film is sintered of typically a temperature range of 400 to 600° C. and preferably in a range of 430-500° C. The sintering step can be made by laser sintering, flash light sintering, thermal sintering or irradiation of IR-light.

### EXAMPLES

Preparations:

Ethylcellulose (Ethocel 45, Dow Chemical) or other binders were dissolved in a mixture of organic solvents according to the amounts displayed in table 1. Commercially available silver particles (Metalor P620-7) were added according to the amounts displayed in table 1 and well dispersed under vigorous stirring.

Particle Size Measurement:

The inks of Examples 1 to 3 were further diluted in isopropanol under impact of ultra sound and the particle size distribution was measured using a Mastersizer 2000. The data was evaluated as volume averaged data according to the Mie-theory mode using the blue light of the instrument (λ=466 nm) and as optical constants for the refractive index=0.14 and for the absorption constant=3.99.

A d₅₀ of 180 nm-210 nm was determined for all inks. The d₉₀-value was in a range of 750 to 850 nm.

The flash point was measured using the method of Abel according to EN ISO 13736 using a flash point detector ABA 4 (Petrotest) and cyclohexanone and 1-hexanol as secondary standards.

Comparative Example 7: An ink according to Example 3 was prepared, but with a silver particle of a d₅₀-value of about 2.1 μm and a d₉₀-value of about 3.7 μm (Metalor P554-32).

It was not possible to print this ink as the nozzles of the printing head were clogged.

TABLE 1
Prepared compositions (all amounts in wt.-%)

| | | | | Comp. | Comp. | Comp. |
|---|---|---|---|---|---|---|
| Compound: | Ex. 1 | Ex. 2 | Ex. 3 | Ex. 4 | Ex. 5 | Ex. 6 |
| Silver particles | 20 | 20 | 20 | 20 | 20 | 20 |
| Particle size | | | | | | |
| Neocryl B725 | | | | 1 | | |
| (acrylate) | | | | | | |
| Ethyl cellulose | 1 | 1 | 1 | | | |
| (Ethocel 45) | | | | | | |
| Mowital B20H | | | | | 1 | |
| (PVB) | | | | | | |
| Polyvinyl | | | | | | 1 |
| pyrrolidone Luviscol | | | | | | |
| 17 | | | | | | |
| Isopropanol | 40 | | | | | |
| Ethylacetate | | 40 | | | | |
| Dowanol PnB | | | 40 | 40 | 40 | 40 |
| (propylenglycol n- | | | | | | |
| butylether) | | | | | | |
| Butylglycol acetate | 19 | 19 | 19 | 19 | 19 | 19 |
| dipropylene glycol | 20 | 20 | 20 | 20 | 20 | 20 |
| dimethylether | | | | | | |
| Flash point | 17° C. | 4° C. | 63° C. | 63° C. | 63° C. | 63° C. |

Directly after mixing, the obtained compositions were filled into glass test tubes. Dispersion stability tests were performed by keeping the thus filled test tubes without further mixing for some time at room temperature and at elevated temperature (45° C.). At regular time intervals the test tubes were assessed. The results of these tests are summarized in tables 2 and 3.

In the assessment the following scoring was used:
0 no precipitation visible
1 first sign of precipitation visible on bottom of test tube
2 some slight precipitation visible on bottom of test tube
3 some precipitation visible on bottom and top of test tube
4 precipitation clearly visible
5 majority of silver particles precipitated on the bottom of test tube

TABLE 2
Assessment stability tests at room temperature

| | Exposure time (in days) at room temperature | | | | | | |
|---|---|---|---|---|---|---|---|
| Example | 3 | 5 | 7 | 10 | 14 | 21 | 28 |
| Ex. 1 | 0 | 0 | 1 | 1 | 1 | 1 | 2 |
| Ex. 2 | 0 | 0 | 1 | 1 | 1 | 1 | 2 |
| Ex. 3 | 0 | 0 | 1 | 1 | 1 | 1 | 2 |
| Comp. | 5 | 5 | 5 | 5 | 5 | 5 | 5 |
| Ex. 4 | | | | | | | |
| Comp. | 5 | 5 | 5 | 5 | 5 | 5 | 5 |
| Ex. 5 | | | | | | | |
| Comp. | 0 | 0 | 2 | 2 | 3 | 4 | 4 |
| Ex. 6 | | | | | | | |

TABLE 3
Assessment stability tests at 45° C.

| | Exposure time (in days) at 45° C. | | | | | | |
|---|---|---|---|---|---|---|---|
| Example | 3 | 5 | 7 | 10 | 14 | 21 | 28 |
| Ex. 1 | 0 | 0 | 1 | 1 | 1 | 2 | 3 |
| Ex. 2 | 0 | 0 | 1 | 1 | 3 | 3 | 3 |
| Ex. 3 | 0 | 0 | 1 | 1 | 1 | 2 | 3 |
| Comp. | 5 | 5 | 5 | 5 | 5 | 5 | 5 |
| Ex. 4 | | | | | | | |
| Comp. | 5 | 5 | 5 | 5 | 5 | 5 | 5 |
| Ex. 5 | | | | | | | |
| Comp. | 0 | 0 | 4 | 4 | 4 | 4 | 4 |
| Ex. 6 | | | | | | | |

Clearly the inks of the inventive Examples had a much better stability with regard to sedimentation than the Comparative examples. This effect is attributed to the stabilizing properties of ethyl cellulose. The small amount of sedimented particles seen after 28 days could be easily redispersed using ultra sound treatment. A redispersion was even possible after one year of sedimentation. The sedimented pigments from the comparative examples could not completely be redispersed as agglomeration had started to be irreversible here.

Procedure Conductivity Measurement:

A xy-100-table (Konica Minolta) was combined with a print head control system of GIS and an ink feeding system (Jet-set Industrial, print head: X1002 from Xaar). As a substrate a transparent PET foil (Hostaphan GN 4660/175 μm) was used. The printing ink of Example 3 was printed thereon in a pattern. The Ink was dried at 40° C. (about 5 min) and then sintered using a Xe-flash lamp as light source (Pulseforge (Novacentrix) with a pulse envelope for two flashs with durations of each 2,000 μs and 1,700 μs 4 using a voltage of 350 V). The thickness of the dried film was 3 μm.

The conductivity was measured form a rectangle with 10 cm×2 cm. The conductivity of the films were measured using a 4 point measurement at a voltage of 10 V using a Loresta-GP MCP-T610 apparatus (Mitsubishi Chemical Analytech). The volume resistance was 1.0×10⁻⁴ Ωcm and the sheet resistance was 3.3×10⁻¹Ω/□. These values are very low for a film of a thickness of 3 μm.

1. An ink jet printing ink composition comprising:
60-84.5 wt.-% of one or more organic solvents,
0.5-5 wt.-% of a binder, wherein the binder comprises ethyl cellulose in an amount ranging from 85 to 100 wt.-%, based on the total weight of the binder, and
15-25 wt.-% of silver particles having a d₅₀-value in a range of 130 nm to 800 nm,
wherein wt % of the one or more organic solvents, the binder, and the silver particles are based on the total weight of the ink jet printing ink composition.

2. The ink jet printing ink composition according to claim 1, wherein the ink jet printing ink composition comprises one or more organic solvents, the binder, and an optional dispersing agent in an amount ranging from 95 to 100 wt.-%, based on the total weight of the ink jet printing ink composition.

3. The ink jet printing ink composition according to claim 1, wherein the ink jet printing ink composition has a flash point of at least 61° C.

4. The ink jet printing ink composition according to claim 1, wherein the silver particles have a d₉₀-value in a range of 500 to 2,500 nm.

5. The ink jet printing ink composition according to claim 1, wherein the binder comprises ethyl cellulose in an amount ranging from 95 to 100 wt.-%, based on the total weight of the binder.

6. The ink jet printing ink composition according to claim 5, wherein the binder is ethyl cellulose.

7. The ink jet printing ink composition according to claim 1, wherein the ratio of the amount of binder to the amount of silver particles is in a range of 3% to 10%.

8. The ink jet printing ink composition according to claim 1, wherein the ink jet printing ink composition has a viscosity in a range of 3 to 25 mPas, determined at a temperature of 25° C. with a Brookfield rotational viscosimeter LV, Model DV-II+ using spindle no. 61 at 100 rpm.

9. The ink jet printing ink composition according to claim 1, wherein the ink jet printing ink composition does not contain any conductive particles based on carbon.

10. The ink jet printing ink composition according to claim 1, wherein the silver particles are essentially spherical particles.

11. The ink jet printing ink composition according to claim 1, wherein the one or more organic solvents include any one or more of methyl alcohol, ethyl alcohol, propyl alcohol, butyl alcohol or isopropyl alcohol, acetone, methylethyl ketone, cyclohexanone methyl acetate, ethyl acetate, propyl acetate, butyl acetate, methyl propionate, ethyl propionate diethyl ether, dipropyl ether, tetrahydrofuran, dioxane, ethylene glycol based ether containing a methyl, n-propyl, propyl, n-butyl, i-butyl, hexyl, or 2-ethyl hexyl resin group and an allyl or phenyl group having a double bond as a base, propylene glycol based ether containing a methyl, n-propyl, i-propyl, n-butyl, i-butyl, hexyl, or 2-ethyl hexyl resin group and an allyl or phenyl group having a double bond as a base, ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monomethyl ether, dipropylene glycol monomethyl ether, dipropylene glycol monoethyl ether, ethylene glycol dimethyl ether, ethylene glycol diethyl ether, ethylene glycol dibutyl ether, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

12. The ink jet printing ink composition according to claim 11, wherein the one or more organic solvents comprises a blend of an alkylene glycol diether and an alkylene glycol monoether.

13. A method of producing an ink jet printing ink composition, the method comprising:
providing a silver particle dispersion having a d₅₀-value in a range of 130 nm and 800 nm and optionally coating the silver particles with a dispersing agent,
optionally drying the silver particle dispersion,
preparing a first dispersion by dissolving a binder in one or more organic solvents, the binder comprising ethyl cellulose in an amount ranging from 85 to 100 wt.-%, based on the total weight of the binder,
adding the silver particle dispersion or the dried silver particle dispersion to the first dispersion under stirring and/or impact of ultrasound, the method yielding an ink jet printing ink composition comprising:
60-84.5 wt.-% of one or more organic solvents, 0.5-5 wt.-% of a binder, wherein the binder comprises ethyl cellulose in an amount ranging from 85 to 100 wt.-%, based on the total weight of the binder, 15-25 wt.-% of silver particles having a d₅₀-value in a range of 130 nm to 800 nm, wherein wt % of the one or more organic solvents, the binder, and the silver particles are based the total weight of the ink jet printing ink composition.

14. A process of drop-on-demand ink jet printing, comprising applying the ink jet printing ink composition of claim 1 on a substrate to form a conductive layer.

15. A process of applying a conductive line or a pattern to a substrate, the process comprising:
printing the ink jet printing ink composition of claim 1 on a substrate by a drop-on-demand ink jet process or a continuous ink jet process,
optionally drying the printed ink jet printing ink composition at temperatures of 35° C. to 80° C., and
sintering the printed ink jet printing ink composition at temperatures of 400 to 600° C.

16. The ink jet printing ink composition according to claim 1, wherein the ink jet printing ink composition does not contain any conductive particles based on graphite, graphene or carbon nanotubes.

17. The ink jet printing ink composition according to claim 11, wherein the one or more organic solvents is a blend of an alkylene glycol diether and an alkylene glycol monoether.

18. The ink jet printing ink composition according to claim 1, including an antioxidizing agent.

19. The ink jet printing ink composition according to claim 1, including a dispersing agent for the silver particles, the dispersing agent being different from the binder.
